(19) United States
(12) Patent Application Publication
(10) Pub. No.: US 2025/0073998 A1
(43) Pub. Date: Mar. 6, 2025

(54) TRANSPORTING MICROPARTICLES TO TARGET LOCATIONS USING 4-DIMENSIONAL (4D) OBJECTS

(71) Applicant: International Business Machines Corporation, Armonk, NY (US)

(72) Inventors: Su Liu, Austin, TX (US); Tushar Agrawal, West Fargo, ND (US); Vinod A. Valecha, Pune (IN); Sarbajit K. Rakshit, Kolkata (IN)

(21) Appl. No.: 18/238,956

(22) Filed: Aug. 28, 2023

(51) Int. Cl. B29C 64/321; B29C 64/393; B82Y 40/00

(52) U.S. Cl. CPC B29C 64/321; B29C 64/393; B82Y 40/00; B33Y 50/02

(57) ABSTRACT

A computer-implemented method, according to one approach, includes: sending one or more instructions to apply an initial influencing factor to smart materials of a 4D object. Moreover, the 4D object is configured to deliver one or more microparticles from a start location to a target location along a delivery path in response to the initial influencing factor being applied to the smart materials. One or more instructions to monitor movement of the 4D object along the delivery path in response to applying the initial influencing factor to the smart materials are also sent. In response to determining the 4D object has deviated from the delivery path, one or more instructions to use one or more machine learning models to dynamically weight the initial influencing factor applied to the smart materials are further sent.

### BACKGROUND

The present disclosure relates to microparticles, and more specifically, this disclosure relates to transporting microparticles to target locations using 4D objects.

“Microparticles” are particles that have a physical dimension (e.g., diameter) between approximately 1 and 1000 micrometers (m). Microparticles have traditionally been available as raw materials, such as ceramics, glass, polymers, and metals. Microparticles are also encountered naturally in daily life, such as pollen, sand, dust, flour, and powdered sugar.

While traditional microparticles have been limited to naturally occurring items and small amounts of material, advances in technology have allowed for the further miniaturization of functional components in a number of different technological fields. As a result, microparticles have become more advanced, and may be used in a number of situations to achieve a desired result. For example, advances in medicine have allowed for the development of biodegradable microparticles. These biodegradable microparticles may be capable of serving as cell microcarriers, drug delivery vessels, 3-dimensional scaffolds, etc. In other examples, microparticles may be used to assemble electronic particles, small mechanical particles, etc.

It follows that microparticles are particularly useful in a number of situations that involve limited space, but the small size of microparticles also impacts the process of how they may be handled. Forming and storing microparticles is thereby a detailed and precise process. Physical systems that are precise enough to handle microparticles are often too large themselves to reach the target location for the microparticles.

### SUMMARY

A computer-implemented method, according to one approach, includes: sending one or more instructions to apply an initial influencing factor to smart materials of a 4D object. Moreover, the 4D object is configured to deliver one or more microparticles from a start location to a target location along a delivery path in response to the initial influencing factor being applied to the smart materials. One or more instructions to monitor movement of the 4D object along the delivery path in response to applying the initial influencing factor to the smart materials are also sent. In response to determining the 4D object has deviated from the delivery path, one or more instructions to use one or more machine learning models to dynamically weight the initial influencing factor applied to the smart materials are further sent.

A computer program product, according to another approach, includes a computer readable storage medium having program instructions embodied therewith. Moreover, the program instructions are readable by a processor, executable by the processor, or readable and executable by the processor, to cause the processor to: perform the foregoing method.

A system, according to yet another approach, includes: a processor, in addition to logic that is integrated with the processor, executable by the processor, or integrated with and executable by the processor. Moreover, the logic is configured to: perform the foregoing method.

Other aspects and implementations of the present disclosure will become apparent from the following detailed description, which, when taken in conjunction with the drawings, illustrate by way of example the principles of the disclosure.

### BRIEF DESCRIPTION OF THE DRAWINGS

FIG. 1 is a diagram of a computing environment, in accordance with one approach.

FIG. 2 is a representational view of a distributed system, in accordance with one approach.

FIG. 3A is a flowchart of a method, in accordance with one approach.

FIG. 3B is a flowchart of sub-processes for one of the operations in the method of FIG. 3A, in accordance with one approach.

FIG. 3C is a flowchart of sub-processes for one of the operations in the method of FIG. 3A, in accordance with one approach.

FIG. 4 is a flowchart of a method, in accordance with one approach.

### DETAILED DESCRIPTION

The following description is made for the purpose of illustrating the general principles of the present disclosure and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for evaluating microparticle delivery requests, generating (e.g., designing and constructing) a 4D object configured to satisfy the request efficiently, and improving performance of the 4D object over time based on use. Implementations herein are thereby able to process microparticles and deliver them to intended target locations despite spatial limitations being involved. The process of generating the 4D objects involves using trained machine learning models to evaluate characterizing details of a microparticle delivery request received, and determine a 4D object configured to deliver the microparticles to a target location most efficiently, e.g., as will be described in further detail below.

In one general approach, a computer-implemented method includes: sending one or more instructions to apply an initial influencing factor to smart materials of a 4D object. The 4D object is configured to deliver one or more microparticles from a start location to a target location along a delivery path in response to the initial influencing factor being applied to the smart materials. It follows that in contrast to conventional shortcomings, approaches herein are able to handle microparticles and deliver them to intended target locations despite spatial limitations being involved. Implementations herein achieve this significant increase in the applicability of microparticles as a result of developing (e.g., designing and printing) 4D objects that are configured to transport microparticles in response to influencing factors being applied and without relying on any machinery.

The computer-implemented method also includes sending one or more instructions to monitor movement of the 4D object along the delivery path in response to applying the initial influencing factor to the smart materials. Again, the 4D object preferably includes smart materials and static materials. Smart materials are configured to physically deform in response to one or more initial influencing factors being applied thereto, while static materials do not noticeably physically deform under nominal operating conditions (e.g., temperatures). Accordingly, performance of the 4D object to be reviewed in the presence of different influencing factors. Determinations may thereby be made as to whether the 4D object is traveling towards an intended target location and/or along an intended delivery path. This reduces the number of failures experienced while satisfying microparticle delivery requests.

In response to determining the 4D object has deviated from the delivery path, some implementations send one or more instructions to use machine learning models to dynamically weight the initial influencing factor applied to the smart materials. It follows that the one or more influencing factors may further be dynamically adjusted in response to determining that the 4D printed object has deviated from an intended delivery path. For instance, one or more trained machine learning models may be used to dynamically weight the influencing factor applied to the smart materials in real-time, thereby impacting (e.g., improving) movement of the 4D printed object. These adjustments preferably direct the 4D object back towards or on an intended deliver path towards the target location.

In some implementations, dynamically applying a weight to an influencing factor includes: determining an amount of force generated by the 4D object in response to the initial influencing factor being applied to the smart materials. As noted above, influencing factors may cause smart materials to physically deform in different ways depending on the type of smart material, type of influencing factors applied, intensity (e.g., weight) of the influencing factors applied, etc. Determining the amount of force generated by the 4D object in response a given influencing factor being applied thereto provides insight as to how the 4D object reacts in a given situation. This information may thereby be used to interpret performance and adjust settings accordingly to improve efficiency.

Accordingly, some implementations include comparing the amount of force generated by the 4D object, to the movement of the 4D object along the delivery path in response to applying the initial influencing factor to the smart materials. Based on this evaluation, a weight value may be generated. Again, one or more trained machine learning models may be used to perform this comparison and dynamically weight the influencing factor applied to the smart materials in real-time. This desirably redirects movement of the 4D printed object towards the intended delivery path. These adjustments may thereby also redirect the 4D object and microparticles back towards the target location. Accordingly, the weight value may be configured to adjust movement of the 4D object back along the delivery path in response to applying the weight value to the influencing factor.

In some implementations, the one or more machine learning models are trained using a repository of characteristic data corresponding to different influencing factors and how they impact the physical deformation of different smart materials. For instance, in different implementations the influencing factor may include one or more of light, heat, magnetic fields, sound, and electricity. In some implementations, the repository also includes characteristic data corresponding to different ambient environments and how they impact the physical deformation of the respective smart materials in the repository. Repositories may thereby be formed and used to improve the process of developing a 4D object that is configured to efficiently satisfy a microparticle delivery request. This repository may thereby be used to train the machine learning models to understand how each smart material responds (e.g., how it deforms) in the presence of different influencing factors. This repository may be filled using existing smart materials that have already been developed and tested to determine the effects that different influencing factors have on the smart materials. Information received from 4D objects that are created and used to transport microparticles may also be used to supplement repositories of information used to train the machine learning models herein. It follows that the machine learning models are trained using a repository of characteristic data and how that data impacts the physical deformation of different smart materials.

In some implementations, it may be determined that the 4D object has not deviated from the delivery path while delivering the microparticles to the target location. Accordingly, one or more instructions to maintain the initial influencing factor applied to the smart materials may be sent. This desirably ensures that the current influencing factor is causing the 4D object to move the microparticles towards the target along the delivery path. However, in response to determining that the 4D object has reached the target location, one or more instructions may be sent to remove the initial influencing factor from being applied to the smart materials. This ensures that the microparticles remain at the target location and do not continue traveling past the target location. As a result, the microparticle delivery request is satisfied.

In another general approach, a computer program product includes a computer readable storage medium having program instructions embodied therewith. Moreover, the program instructions are readable by a processor, executable by the processor, or readable and executable by the processor, to cause the processor to: perform the foregoing method.

In yet another general approach, a system includes: a processor, in addition to logic that is integrated with the processor, executable by the processor, or integrated with and executable by the processor. Moreover, the logic is configured to: perform the foregoing method.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approaches (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved microparticle delivery code at block 150 for evaluating microparticle delivery requests, generating (e.g., designing and constructing) a 4D object configured to satisfy the request efficiently, and improving performance of the 4D object over time based on use. The improvement is achieved, at least in part, as a result of using each SNAT port to facilitate multiple connections to a same destination IP address and DNS port. This desirably reduces processing backlog as well as the number of received requests that fail.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

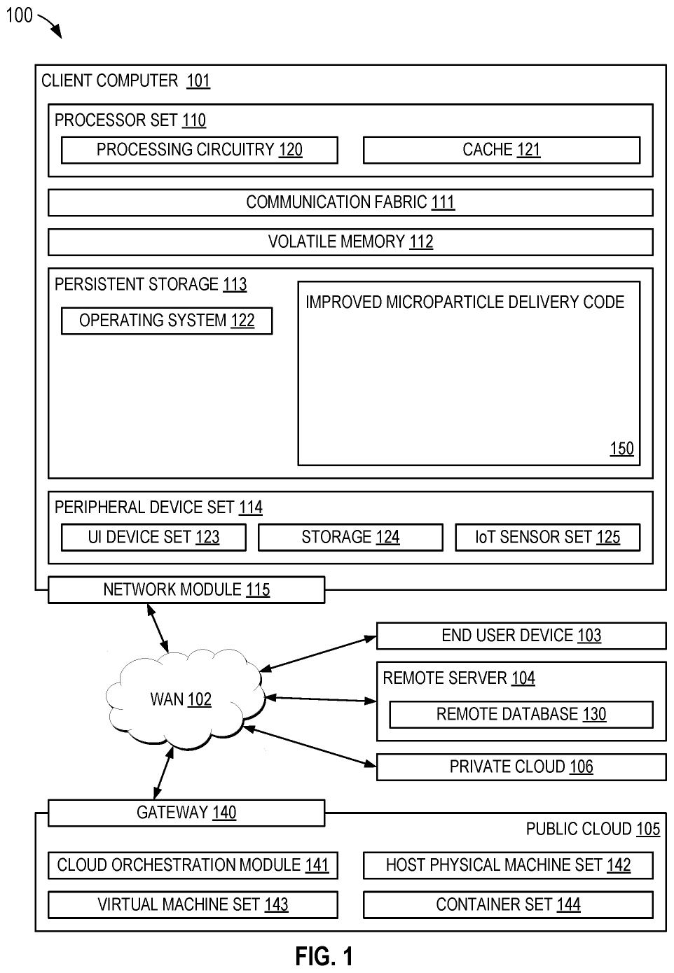

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various implementations.

As noted above, “microparticles” are particles that have a physical dimension (e.g., diameter) between approximately 1 and 1000 micrometers (m). Microparticles have traditionally been available as raw materials, including ceramics, glass, polymers, and metals. Microparticles are also encountered naturally in daily life, such as pollen, sand, dust, flour, and powdered sugar.

While traditional microparticles have been limited to naturally occurring items and small amounts of material, advances in technology have allowed for the further miniaturization of functional components in a number of different technological fields. As a result, microparticles have become more advanced, and may be used in a number of situations to achieve a desired result. For example, advances in medicine have allowed for the development of biodegradable microparticles. These biodegradable microparticles may be capable of serving as cell microcarriers, drug delivery vessels, 3-dimensional scaffolds, etc. In other examples, microparticles may be used to assemble electronic particles, small mechanical particles, etc.

It follows that microparticles are particularly useful in a number of situations that involve limited space, but the small size of microparticles also makes them difficult to handle. This is particularly true for robotic systems that lack the precision associated with forming and/or handling microparticles. Similarly, robotic systems that are precise enough to handle microparticles are often much too large themselves to reach the target location for the microparticle. Thus, conventional systems have only been able to use microparticles in a limited number of instances, and there exists a need for methods and systems that facilitate the transportation of microparticles to appropriate target locations.

In sharp contrast to the conventional shortcomings above, implementations herein are able to handle microparticles and deliver them to intended target locations despite spatial limitations being involved. Implementations herein achieve this significant increase in the applicability of microparticles as a result of developing (e.g., designing and printing) 4D objects that are configured to transport microparticles without relying on any machinery. Rather, 4D objects herein are able to transport microparticles as a result of implementing smart materials in different configurations, e.g., as will be described in further detail below.

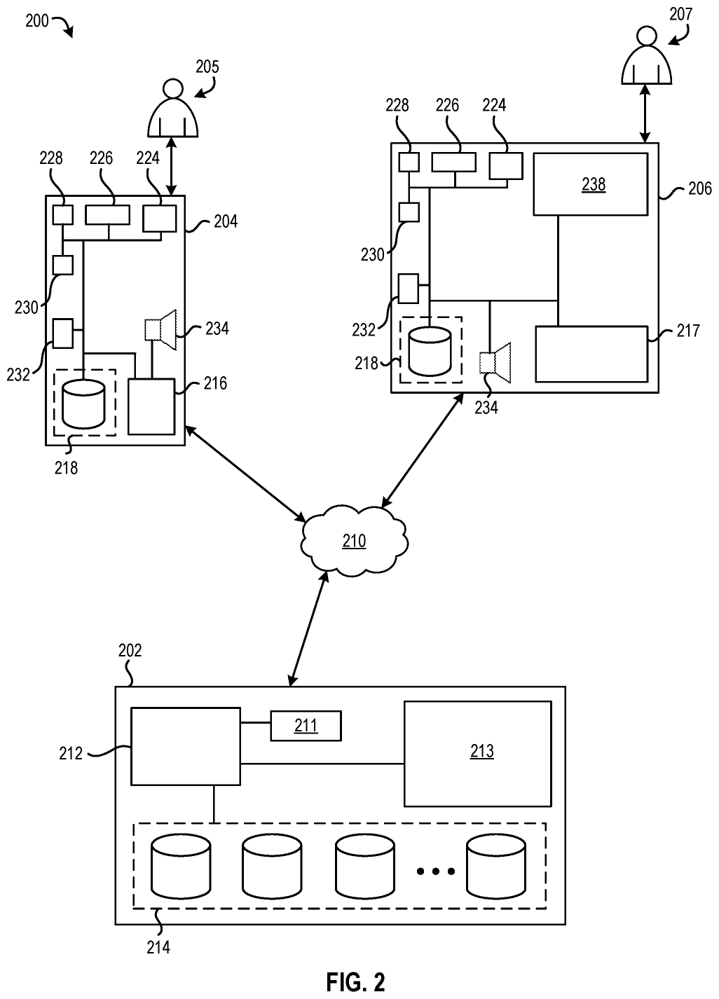

Looking now to FIG. 2, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2 (and the other FIGS.) may be deemed to include any possible permutation.

As shown, the system 200 includes a central server 202 that is connected to remote locations 204, 206 accessible to the respective users 205, 207. Each of these remote locations 204, 206 and respective users 205, 207 may be separated from each other such that they are positioned in different geographical locations. For instance, the central server 202 and remote locations 204, 206 are connected to a network 210.

The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between users 205, 207 at the remote locations 204, 206 and/or central server 202, regardless of the amount of separation which exists therebetween, e.g., despite being positioned at different geographical locations.

However, it should be noted that two or more of the remote locations 204, 206 and/or central server 202 may be connected differently depending on the approach. According to an example, which is in no way intended to limit the disclosure, two edge compute nodes may be located relatively close to each other and connected by a wired connection, e.g., a cable, a fiber-optic link, a wire, etc.; etc., or any other type of connection which would be apparent to one skilled in the art after reading the present description. The term “user” is in no way intended to be limiting either. For instance, while users are described as being individuals in various implementations herein, a user may be an application, an organization, a preset process, etc. The use of “data” and “information” herein is in no way intended to be limiting either, and may include any desired type of details, e.g., depending on the type of prompt (e.g., request) submitted by a user.

With continued reference to FIG. 2, the remote locations 204, 206 are shown as having a different configuration than the central server 202. For example, in some implementations the central server 202 includes a large (e.g., robust) processor 212 coupled to a cache 211, a machine learning module 213, and a data storage array 214 having a relatively high storage capacity. The machine learning module 213 may include any desired number and/or type of machine learning models. In preferred approaches, the machine learning module 213 includes machine learning models that have been trained to analyze the details submitted in a request to transport microparticles from a start location to a target location along an intended path. These machine learning models may be able to evaluate various details associated with the microparticles, start location, target location, intended path, etc., to determine a most efficient option for satisfying the request.

It follows that the machine learning models in machine learning module 213 may be trained using collections of information (e.g., characteristic data) which include combinations of various 4D objects capable of delivering microparticles; microparticles of various shapes, sizes, weights, etc.; delivery paths intended to be used to deliver microparticles to a target location; ambient environments (e.g., intestinal tract, artery, industrial environment, etc.) along the intended delivery path; etc. It follows that processor 212 and/or machine learning module 213 may perform one or more of the operations included in method 300, e.g., as will be described in further detail below.

With continued reference to FIG. 2, it follows that processor 212 and/or machine learning module 213 may be used to monitor requests that are received from user 205. As noted above, the requests may involve transporting microparticles to a target location. Accordingly, the user 205 may submit a request at remote location 204 for microparticles to be delivered to a target location, and the request is sent to the central server 202 for processing. Results generated by processing the request may thereby be sent to remote location 206 such that a 4D object capable of delivering the microparticles to the target location is constructed and used to transport the microparticles. Requests may thereby be evaluated as they are received in real-time and used to determine 4D objects capable of delivering microparticles to target locations identified in the requests.

Looking to remote location 204, a processor 216 coupled to memory 218 receives inputs from and interfaces with user 205. For instance, the user 205 may input information using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc. The remote location 204 also includes a speaker 234 which may be used to play (e.g., project) audio signals for the user 205 to hear.

Some of the components included at remote location 206 may be the same or similar to those included at remote location 204, some of which have been given corresponding numbering. For instance, controller 217 is coupled to memory 218, a display screen 224, keys of a computer keyboard 226, a computer mouse 228, a microphone 230, speaker 234, and camera 232.

Additionally, the controller 217 is coupled to a manufacturing module 238 configured to construct 3D and 4D objects. In some approaches, the manufacturing module 238 may be able to print 3D and/or 4D objects using one or more additive manufacturing procedures. Additive manufacturing procedures may be desirable in some situations, as they can form an object having any desired shape, dimensions, material composition, etc. This improves the ability of a resulting object that is formed to successfully hold and transport microparticles as desired. However, it should be noted that the manufacturing module 238 may be configured to form 3D objects and/or 4D objects using other manufacturing processes.

With respect to the present description, it should also be noted that a “4D object” includes static materials as well as smart materials. The static materials retain a given shape, size, orientation, etc. even during use, while smart materials are configured to physically deform in response to an influencing factor being applied thereto. In other words, applying an appropriate influencing factor (e.g., external stimuli) to a 4D object printed by the manufacturing module 238 causes smart materials of the 4D object to physically deform, while the static materials remain unchanged. For instance, influencing factors may include, but are in no way limited to, visible light, thermal heat, physical stress and/or strain, liquids (e.g., water), magnetic fields, electricity, sound, ultraviolet (UV) light, etc.

According to an example, a robot arm that can bend and move in response to changes in temperature may use a smart material such as shape memory alloy which is able to remember its original shape and return to it when heated. Other static materials, including the frame and joints of the robot, may be 3D printed using additive procedures that use materials such as plastic and metal. Smart materials may thereby be integrated into specific areas of the robot arm, e.g., such as the arm segments or the gripper. Thus, in situations that the robot is exposed to a temperature change, the smart material deforms, causing the arm segment to bend or the gripper to close. This movement would be controlled by the programming of the smart material and could be repeated as needed based on available influencing factors.

Again, by combining the static and smart materials in different combinations and configurations, approaches herein are able to create (e.g., generate) 4D objects that are each configured to achieve a desired result. In other words, by implementing smart materials that physically react to the presence of one or more influencing factors (e.g., external stimuli), a 4D object may be created that acts in a predetermined way while the one or more influencing factors are applied. Moreover, by adjusting the intensity, number, type, etc., of influencing factors that are applied to the 4D object, implementations herein are able to control how the 4D object acts. For instance, in some approaches increasing a weight applied to the influencing factor may cause smart materials of the 4D object to physically deform more drastically in comparison to decreasing the weight applied to the influencing factor. Motion of the 4D object may thereby be directed by adjusting a weight applied to the influencing factor, e.g., as will be described in further detail below.

In some implementations, the manufacturing module 238 may create (e.g., print) a 3D container that is configured to hold a corresponding 4D object. It follows that the 3D container may be designed such that it can hold the 4D object, as well as the microparticles while being transported. The dimensions and shape of the 3D container that is formed may be determined by the size and/or number of microparticles being transported. Moreover, the material(s) used to form the 3D container may be selected such that the resulting structure is strong (e.g., rigid) enough to hold the microparticles and the 4D object during transportation. The container may also be designed such that it can be easily transported to the target location.

In addition to forming the 3D and 4D objects, remote location 206 may be able to use the 3D and/or 4D objects to attempt delivering microparticles to a target location. As noted above, received microparticle delivery requests may specify a size and/or shape of the microparticles, number of microparticles to be delivered, a target location for the microparticles, a start location, etc. Manufacturing module 238 may thereby be configured to couple microparticles to the 3D and/or 4D objects that are formed before placing them at a specified start location. Remote location 206 may also be configured to selectively apply one or more influencing factors to the objects, causing smart materials in the objects to physically deform.

Smart materials in each of the 4D objects are preferably configured to physically deform and generate forces that result in the respective 4D object generating movement relative to the start location (e.g., a point of reference). As previously mentioned, smart materials are materials that have been designed to have one or more properties that can be changed significantly, yet in a controlled fashion, using influencing factors. For example, shape-memory alloys and shape-memory polymers may be used as smart materials in a 4D object. These shape-memory materials may thereby induce and recover large deformations by applying temperature changes or stress changes (e.g., pseudoelasticity). The shape memory effect of the smart materials is caused by martensitic phase change and induced elasticity at higher thermal temperatures, e.g., as would be appreciated by one skilled in the art after reading the present description.

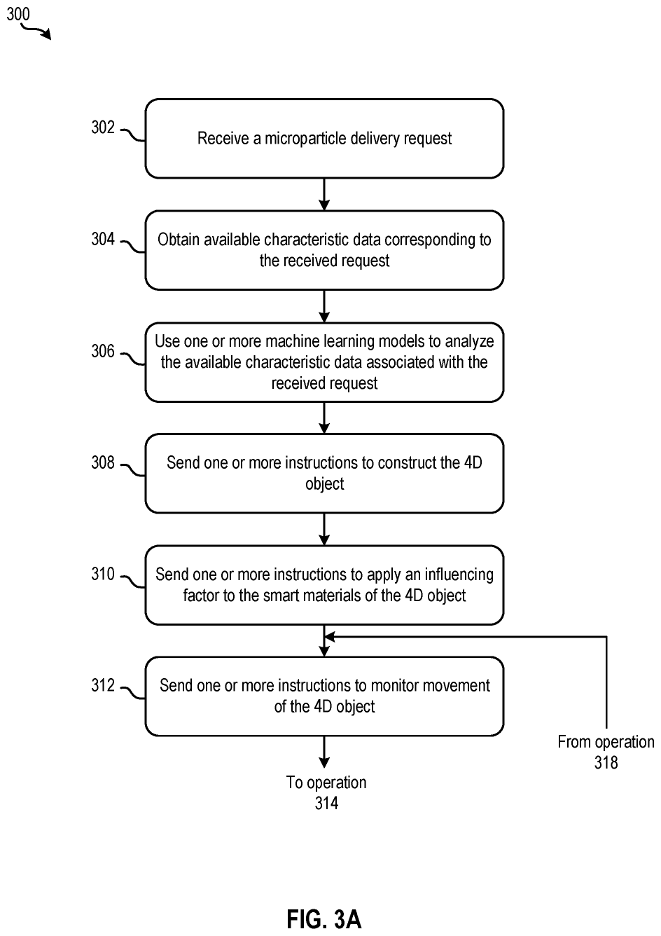

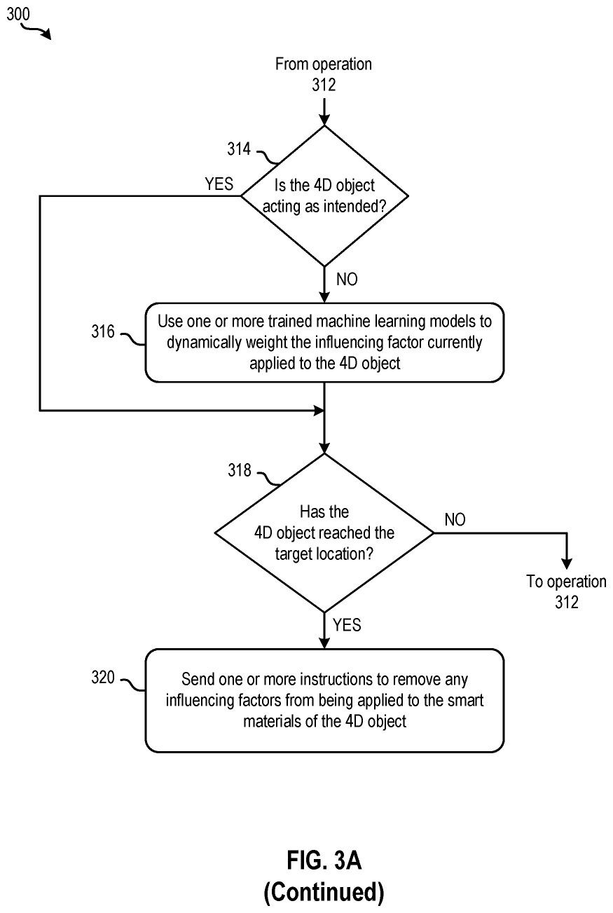

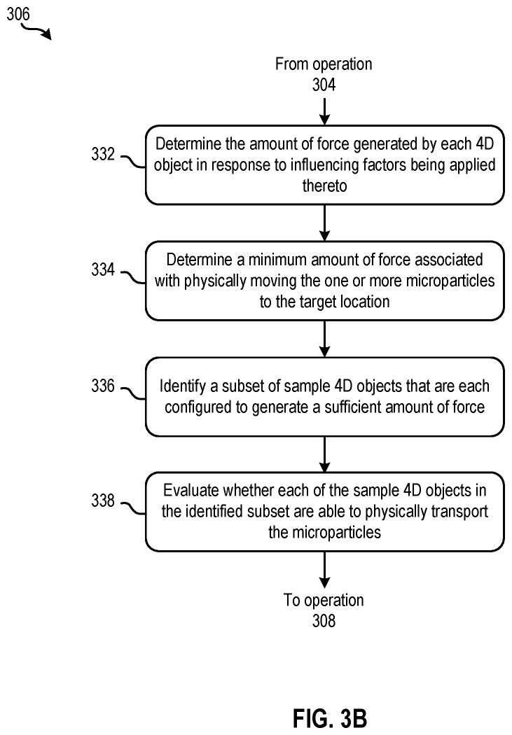

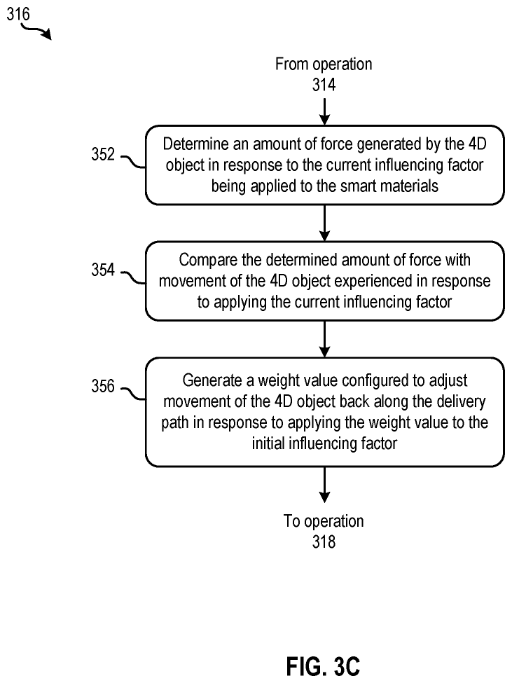

In still other approaches, objects formed at remote location 206 may be sent to another location for testing. For instance, 4D objects printed by manufacturing module 238 may be sent to remote location 204. User 205 may thereby place the 4D object at the start location, and processor 216 may perform one or more of the operations in method 300 of FIG. 3A below. Accordingly, processor 216 may cause one or more influencing factors to be applied to the 4D object, and use a remainder of the components at remote location 204 (e.g., computer keyboard 226, microphone 230, camera 232, etc.) to monitor resulting movement of the 4D object. The one or more influencing factors may further be dynamically adjusted in response to determining that the 4D printed object has deviated from an intended delivery path. For instance, one or more trained machine learning models may be used to dynamically weight the influencing factor applied to the smart materials in real-time, thereby impacting movement of the 4D printed object. These adjustments preferably direct the 4D object back towards or on an intended delivery path towards the target location, e.g., as will be described in further detail below.

According to an in-use example, which is in no way intended to limit the disclosure, a 4D object includes a self-folding body that is configured to transform into a truncated octahedron over time while exposed to a corresponding influencing factor. The 4D object may begin as a series of shapes, a majority of which are in a common plane. However, smart materials of the 4D object may physically react to being exposed to the influencing factor, thereby causing the plane of shapes to transform into a truncated octahedron. Such 4D objects may thereby be used to hold (e.g., encapsulate) one or more microparticles, and transport the microparticles to an intended target location. In some approaches, a 3D object configured to hold microparticles may be coupled to a portion of a 4D object configured to physically move along an intended path to a target location in the presence of one or more influencing factors. The 3D object may thereby be used to hold the microparticles while the 4D object moves the microparticles to the target location.

Looking now to FIG. 3A, a flowchart of a computer-implemented method 300 for transporting microparticles using 4D objects is illustrated in accordance with one approach. In other words, method 300 may be used to develop and use a 4D object to deliver microparticles to a target location. Method 300 also includes causing 4D objects to be constructed, and further making adjustments to operation thereof to improve the process of delivering the microparticles.

Method 300 may be performed in accordance with the present disclosure in any of the environments depicted in FIGS. 1-2, among others, in various approaches. Of course, more or less operations than those specifically described in FIG. 3A may be included in method 300, as would be understood by one of skill in the art upon reading the present descriptions.

Each of the steps of the method 300 may be performed by any suitable component of the operating environment using known techniques and/or techniques that would become readily apparent to one skilled in the art upon reading the present disclosure. For example, one or more processors at a central server in a distributed system (e.g., see processor 212 of FIG. 2 above) may be used to perform one or more of the operations in method 300. In another example, one or more processors at a remote location in a system (e.g., see controller 217 of FIG. 2 above).

Moreover, in various approaches, the method 300 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

Looking to FIG. 3A, operation 302 includes receiving a microparticle delivery request. The request corresponds to delivering one or more microparticles from a start location to a target location along a delivery path. The request may include various details describing the intended delivery of the one or more microparticles. For instance, the request may include characteristic data (e.g., descriptive information) corresponding to the microparticles being delivered, the start location, the target location, the delivery path, one or more ambient environments along the delivery path, etc. According to an example, characteristic data corresponding to the microparticles may include information (e.g., values) that describes a size, shape, weight, surface pattern, material composition, etc. of each microparticle intended to be delivered to a target location.

Accordingly, operation 304 includes obtaining available characteristic data that corresponds to the received request. In other words, operation 304 includes collecting any available characteristic data associated with the received request (e.g., such as the one or more microparticles to be transported). As noted above, at least some of the characteristic data may be received along with the initial request itself. The type, quality, and amount of characteristic data included in the initial request depends on the particular request that is received, as well as other factors, e.g., such as a source of the request. Additional characteristic data may also be collected from other sources in order to supplement any characteristic data that is included in the request. According to an example, characteristic data or other information received along with the initial request may be used to identify related information in a lookup table.

From operation 304, method 300 advances to operation 306. There, operation 306 includes using one or more machine learning models to analyze the available characteristic data associated with the received request. The machine learning models are preferably trained to evaluate characteristic data associated with a microparticle delivery request, and determine (e.g., design) a 4D object that is configured to deliver microparticles to a target location specified in the delivery request.

As noted above, a 4D object may include static materials as well as smart materials. The static materials retain a given shape, size, orientation, etc. even during use, while smart materials are configured to physically deform in response to an influencing factor being applied thereto. The smart materials of a 4D object may thereby be configured to physically react to an influencing factor being applied to the 4D object. In other words, applying an appropriate influencing factor (e.g., external stimuli) to a 4D object causes smart materials of the 4D object to physically deform, while the static materials remain unchanged. For instance, influencing factors may include, but are in no way limited to, visible light, thermal heat, physical stress and/or strain, liquids (e.g., water), magnetic fields, electricity, sound, ultraviolet (UV) light, etc., e.g., depending on the types of smart materials used in a given 4D object.

Again, by combining the static and smart materials in different combinations and configurations, approaches herein are able to create (e.g., design) 4D objects that are each configured to achieve a desired result. In other words, by implementing smart materials that physically react to the presence of one or more influencing factors (e.g., external stimuli), a 4D object may be created that acts in a predetermined way while the one or more influencing factors are applied. Moreover, by adjusting the intensity, number, type, etc., of influencing factors that are applied to the 4D object, implementations herein are able to control how the 4D object acts. For instance, in some approaches increasing a weight applied to the influencing factor may cause smart materials of the 4D object to physically deform more drastically in comparison to decreasing the weight applied to the influencing factor.

Accordingly, each of the 4D objects that are created using the machine learning models are preferably configured such that the physical deformation the smart materials undergo is able to generate a force capable of physically moving the respective 4D object. In other words, the machine learning models are trained to evaluate characteristic data associated with received requests, and develop (e.g., design) 4D objects that are configured to transport microparticles as requested. Physical deformation of the smart materials in these 4D objects result in the 4D object physically moving relative to a start point. Moreover, motion of the 4D object may further be controlled by adjusting a weight applied to the influencing factor, e.g., as will be described in further detail below.

As previously mentioned, the machine learning models used to develop the 4D objects may be trained using training data received from repositories of information. For instance, a machine learning module (e.g., see machine learning module 213 of FIG. 2) may receive, and be trained using, sets of characteristic data associated with various microparticle delivery requests, previously created 4D objects capable of delivering microparticles, the microparticles themselves, available smart materials, ambient conditions along intended delivery paths, the delivery paths, influencing factors, etc.

It follows that information corresponding to 4D objects (e.g., deformation patterns) may be captured over time and stored. For example, a system may be equipped with sensors that capture and log the deformation pattern, movement, etc. data of 4D objects. The logged data can further be stored in a database for historical analysis. In another example, proposed systems can simulate deformation patterns and movements of 4D objects under different conditions. This simulated data may also be stored for historical analysis. In some situations, physical testing may be performed on 4D objects to determine the respective deformation patterns and generated movement.

The machine learning models may also be trained based on the relationships between each of the different types of characteristic data. For instance, the machine learning model may be trained to identify patterns in how certain influencing factors cause certain smart materials to react, how characteristics of the microparticles impact their ability to be transported, how different ambient conditions impact physical deformation of the respective smart materials in the repository and/or motion of a 4D object along an intended delivery path, etc.

A repository of different types of smart materials and how different influencing factors affect each of the respective smart materials may be developed. This repository may thereby be used to train the machine learning models to understand how each smart material responds (e.g., how it deforms) in the presence of different influencing factors. This repository may be filled using existing smart materials that have already been developed and tested to determine the effects that different influencing factors have on the smart materials. Moreover, this information may be represented as characteristic data. However, the repository may also be filled with new smart materials that are synthesized and tested in a lab over time. In some approaches, these properties of the smart materials may be gathered while performing various tests on the smart materials included in the repository. Information received from 4D objects that are created and used to transport microparticles may also be used to supplement repositories of information used to train the machine learning models herein.

It follows that the machine learning models are trained using a repository of characteristic data corresponding to different influencing factors and how they impact the physical deformation of different smart materials. The machine learning models may further be trained to identify how the impacted physical deformation of the smart materials redirects motion of the overall object relative to a target location for the microparticles. It follows that operation 306 is able to evaluate available characteristic data corresponding to a delivery request received, and develop (e.g., design) a 4D object that is able to satisfy the received delivery request.

Referring momentarily now to FIG. 3B, exemplary sub-operations of using trained machine learning models to analyze a microparticle delivery request and determine a 4D object capable of satisfying the request are illustrated in accordance with one approach. One or more of the sub-operations in FIG. 3B may be used to perform operation 306 of FIG. 3A to evaluate characteristic data associated with a received microparticle delivery request, and determine (e.g., design) a 4D object that is configured to deliver microparticles to a target location specified in the delivery request. However, it should be noted that the sub-operations of FIG. 3B are illustrated in accordance with one approach which is in no way intended to limit the disclosure.

As shown, sub-operation 332 includes determining the amount of force generated by each available 4D object in response to influencing factors being applied thereto. In other words, sub-operation 332 includes determining and evaluating an amount of force each 4D object in a repository is able to generate, which can be translated into the amount of weight each available 4D object may be able to physically move. This evaluation may be used to identify certain 4D object configurations that are able to satisfy received microparticle delivery requests. Sub-operation 332 may also identify certain 4D object configurations that are able to travel along a specific delivery path in a particular way (e.g., rolling, crawling, flying, twisting, etc.) towards the target location.

Moreover, sub-operation 334 includes determining a minimum amount of force associated with physically moving the one or more microparticles to the target location. For instance, sub-operation 334 may determine the minimum amount of force associated with physically moving the microparticles along a delivery path as outlined in a received request (e.g., see operation 302 of FIG. 3A). Sub-operation 334 may thereby consider details which impact how the microparticles may be physically moved, e.g., such as their individual and/or combined weight, overall size, etc.

From sub-operation 334, the flowchart proceeds to sub-operation 336. There, sub-operation 336 includes identifying a subset of sample 4D objects that are each configured to generate a sufficient amount of force to move the 4D object and the microparticles. In other words, the 4D objects that are able to generate a force that is greater than the minimum amount of force determined in sub-operation 334. The 4D objects identified in the subset are preferably able to generate at least an amount of force associated with physically moving the microparticles as well as the respective 4D object. The subset of 4D objects that are identified may also be configured to generate physical movement in a specific way, e.g., such as rolling. In still other approaches, the subset of identified 4D objects may have a small enough profile to reach the target location. It follows that ambient environments (e.g., intestinal tract, artery, industrial environment, etc.) along the delivery path may also impact the 4D objects that are considered to satisfy a received microparticle delivery request.

Sub-operation 338 further includes evaluating whether each of the sample 4D objects in the identified subset are able to physically transport the microparticles. In some approaches, this evaluation may involve determining whether the 4D object is configured to receive a container (e.g., package) that contains the one or more microparticles. For instance, the size, shape, chemical composition, etc. of the microparticles may prevent them from being coupled to and/or placed in certain 4D objects. Similarly, these details may prevent certain microparticles from being able to reach the target location, e.g., depending on the delivery path.

Additional factors may also be considered while evaluating the sample (e.g., potential) 4D objects. For instance, identifying 4D objects which are able to transport the microparticles involves evaluating details associated with the microparticles, such as their weight, dimension, shape, etc. The 4D objects that are able to transport microparticles of a particular size may thereby be identified as being able to potentially satisfy the microparticle delivery request.

Ambient environments along the delivery path may also impact how the microparticles are secured to the 4D object. For example, some microparticles may be stored in a watertight compartment of a 4D object in situations where the intended delivery path is through wet environments. In another example, if the microparticles will move through a viscous fluid, the system may need to consider the viscosity of the fluid and the Reynolds number of the flow. The system may also need to take into account any physical or chemical restrictions that may limit the movement of the microparticles, such as electrostatic forces or chemical reactions. It follows that the selection of the appropriate microparticles and their respective movement specifications will be based on the specific application and the details of the task.

In some approaches, the amount and type of mobility associated with delivering the microparticles to a target location is also used to evaluate the available 4D objects. For instance, information associated with the specific task or activity that is involved with delivering the microparticles may be used to identify how the microparticles should be secured within the 4D object. According to an example involving a medical application, the specific movements and flexibility associated with navigating through the human body may be taken into consideration. In another example, objects designed for use in a manufacturing plant may consider the types of movements associated with manipulating and transporting materials in the plant. Again, this information may be used to evaluate possible 4D objects and design a configuration that is able to perform an intended function while maintaining a desired level of mobility and movement.

From sub-operation 338, the flowchart is shown as returning to method 300 of FIG. 3A. It follows that operation 306 is able to use trained machine learning models to analyze the request received in operation 302, and determine a 4D object capable of satisfying the received request in a most efficient manner. As noted above, this may be accomplished by evaluating characteristic data associated with a microparticle delivery request using machine learning models that are trained to generate and recommend a 4D object capable of satisfying the received request.

Proceeding to operation 308, the 4D object determined in operation 306 as being able to satisfy the received request in a most efficient manner, is constructed. In other words, operation 308 includes sending one or more instructions to construct the 4D object output by the machine learning models as a result of performing operation 306. According to some approaches, operation 308 may include sending the one or more instructions to a manufacturing module configured to construct 3D and 4D objects (e.g., see manufacturing module 238 of FIG. 2).

In response to receiving the one or more instructions, the manufacturing module may be able to print the requested 4D object using one or more additive manufacturing procedures. However, it should be noted that the 4D object may be constructed using other manufacturing processes. For instance, the resulting 4D object may include 3D components (e.g., compartments) that are configured to secure the microparticles being delivered. Moreover, the 3D components may be coupled to a surface of the 4D object. The 3D components are preferably attached to the 4D object such that the microparticles securely remain coupled to the 4D object, even while traveling along the intended delivery path.

In situations where the microparticles being transported are relatively small in size and lightweight, they may be directly attached to a surface of the 4D object using one or more adhesives, fasteners, straps, etc. In situations involving heavier and larger microparticles, a customized 3D container may be designed to hold the microparticles as well as the 4D object. The customized container may be designed to attach to the 4D object using clamps, hooks, mechanical fasteners, etc. In some approaches, the 4D object may include a built-in container configured to hold microparticles. Moreover, a mechanism for attaching a container may also be implemented to simplify the attachment process and make it more efficient.

Once the package is securely attached to the 4D object, it is ready to be transported to the target location. It follows that the microparticle container and 4D object become a single unit upon being attached (e.g., coupled) to each other. In other words, once the attachment is made, the microparticle container and the 4D object will move together as a single unit. This attachment may be made using 3D printing, mechanical fastening, adhesive bonding, etc. The attachment is preferably secure enough to ensure the microparticles remain intact and do not detach during the movement of the 4D object along the delivery path. Implementations herein may use simulations and/or testing to verify the strength of the attachment between the microparticles and the 4D object before deploying the system in real-world scenarios.

Additional instructions may also be sent to the manufacturing module, e.g., for testing the 4D object that is constructed. For instance, some implementations test each of the constructed 4D objects to ensure they operate properly before being used in a real-world application. Accordingly, operation 310 includes sending one or more instructions to apply an initial influencing factor to the smart materials of the 4D object. As noted above, the 4D object formed as a result of the one or more instructions sent in operation 306 is configured to deliver microparticles from a start location to a target location along a delivery path in response to a particular influencing factor being applied to the smart materials thereof. Depending on the smart material, the 4D object may be configured to react to different types and intensity of influencing factors. Thus, the initial influencing factor applied to the 4D object may be determined based on the types of smart materials that are used in the 4D object.

Operation 312 includes sending instructions to monitor the movement of the 4D object along the delivery path in response to applying the initial influencing factor. Operation 314 further includes determining whether the 4D object is acting as intended in the presence of the initial influencing factor(s). In other words, operation 314 evaluates the direction, speed, acceleration, etc. of the 4D object, and determines whether the 4D object is currently traveling towards an intended target location. Operation 314 may also consider whether the 4D object is currently traveling towards the intended target location along an intended delivery path.

Method 300 is shown as proceeding from operation 314 to operation 316 in response to determining that the 4D object has deviated from the delivery path. As noted above, the location, direction of movement, speed, etc. of a 4D object may be monitored differently depending on the approach. For instance, some approaches may monitor the movement of the 4D object by evaluating pictures and/or video captured by a camera using machine learning models, e.g., as would be appreciated by one skilled in the art after reading the present description.

For instance, the movement of the 4D object may be monitored using computer vision techniques, e.g., such as object detection and tracking. The captured video feed may be processed using object detection algorithms to identify the 4D objects and the microparticles. Object tracking algorithms may further be used to track the movement of the 4D object and the microparticles over time. Any deviation or change in the movement pattern can thereby be identified by analyzing the tracking data.

Sensor-based systems can also be used to monitor the movement of a 4D object and identify any deviation from an intended delivery path. Sensors may include accelerometers and/or gyroscopes which may be attached to the 4D object and/or microparticle container, to measure their movement and orientation. The sensor data can also be processed to identify any deviation from the intended delivery path. In other words, in situations where the 4D object deviates from the intended delivery path, the sensor data will reflect this change in movement which will be identified and flagged.

Referring still to FIG. 3A, method 300 may thereby proceed to operation 316 in response to identifying the 4D object is no longer on an intended delivery path. There, operation 316 includes using one or more trained machine learning models to dynamically weight the influencing factor currently applied to the 4D object. As noted above adjusting the intensity, number, type, etc., of influencing factors that are applied to the 4D object control how the smart materials act. For instance, in some approaches increasing a weight applied to the influencing factor may cause smart materials of the 4D object to physically deform more drastically in comparison to decreasing the weight applied to the influencing factor. Motion of the 4D object may thereby be directed by adjusting a weight applied to the influencing factor in real-time.

The shape (e.g., dimensions) of the 4D object may also impact the weight applied to the influencing factor. The shape of a 4D object may be determined in some approaches using various sensors and/or tracking systems such as cameras, pressure sensors, motion sensors, etc. These sensors can be placed at strategic locations on the 4D object to determine its shape and the movement of different portions during deformation. The captured data can be processed and analyzed by machine learning models to track the pattern of deformation over time. This information can be used to monitor the performance of the 4D object and make any adjustments and/or repairs to improve its functionality.

Referring momentarily to FIG. 3C, exemplary sub-operations of using machine learning models to dynamically weight the influencing factor currently applied to a 4D object are illustrated in accordance with one approach. It follows that the sub-operations of FIG. 3C are preferably performed in real-time as information is received (e.g., received from sensors and processed). For instance, the machine learning models may evaluate deformation of a 4D object while it is moving relative to the influencing factors applied.

In some approaches, this evaluation may involve analyzing the changes in shape and dimension of the 4D object as it moves, and how those changes relate to the forces acting upon it. This can help identify any areas of the 4D object that are experiencing higher stress or strain than desired, and further improve the design to increase operational efficiency and durability. One or more of the sub-operations in FIG. 3C may thereby be used to perform operation 316 of FIG. 3A. However, it should be noted that the sub-processes of FIG. 3C are illustrated in accordance with one approach which is in no way intended to limit the disclosure.

In some approaches, the machine learning models may include convolutional neural networks (CNNs) and/or other types of deep learning algorithms that are able to perform image analysis and recognition tasks. For instance, CNNs include multiple layers of convolutional and pooling operations, which may be used to identify features in complex datasets, e.g., such as images. The output of the convolutional layers may then be passed through fully connected layers, which are used to make predictions based on the identified features.

According to an example, CNNs may be used to analyze the deformation patterns of 4D objects, where the input data being analyzed includes images and/or videos of the 4D objects undergoing deformation. The CNNs would then be trained to identify patterns in the deformation that correspond to specific types and intensities of influencing factors. For example, CNNs may learn to recognize that a particular pattern of deformation corresponds to a specific type of force being applied to a particular 4D object. Once trained, the CNNs may be used to analyze new images or videos of 4D objects undergoing deformation and moving. Moreover, these CNNs may be able to dynamically generate adjustments to the types and intensities of influencing factors applied to the 4D objects to ensure they remain on the intended delivery path.

Referring still to FIG. 3C, sub-operation 352 includes determining an amount of force generated by the 4D object in response to the current influencing factor being applied to the smart materials. Moreover, sub-operation 354 includes comparing the amount of force determined in sub-operation 352, with movement the 4D object experienced in response to applying the current influencing factor. Furthermore, sub-operation 356 includes generating a weight value configured to adjust movement of the 4D object back along the delivery path in response to applying the weight value to the initial influencing factor.

By comparing the amount of force that was generated to the actual amount of movement the 4D object experienced, machine learning models may be used to determine how the influencing factor should be adjusted to ensure the 4D object is on the intended delivery path.

To achieve this, the displacement of the 4D printed robot and relative deformation of the smart materials are preferably measured. The displacement can be measured using various sensors, e.g., such as strain gauges, displacement sensors, etc. The system can thereby calculate the force that is generating the displacement, depending on factors such as the type of smart material used, its properties, the magnitude of the deformation caused by the external factors, etc. It should also be noted that machine learning models may be trained using a repository of characteristic data and how the different types of characteristic data interact with each other. It follows that any of the machine learning models described herein may be implemented to perform sub-operations 352, 354, 356 of FIG. 3C.

Returning to FIG. 3A, method 300 is shown as proceeding from operation 316 to operation 318. Similarly, method 300 advances from operation 314 to operation 318 in response to determining that the 4D object is acting as intended in the presence of the current influencing factor(s). In other words, method 300 proceeds to operation 318 from operation 314 in response to determining that the 4D object is back on the intended delivery path.

There, operation 318 includes determining whether the 4D object has reached the target location. In response to determining that the 4D object has not yet reached the target location, method 300 returns to operation 312 such that motion of the 4D object may continue to be monitored. However, in response to determining that the 4D object has reached the target location, method 300 proceeds from operation 318 to operation 320. There, operation 320 includes sending one or more instructions to remove any influencing factors from being applied to the smart materials of the 4D object. By removing the influencing factors, the 4D object preferably stops moving.

Method 300 may end in response to sending the one or more instructions in operation 320. However, it should be noted that although method 300 may end upon reaching operation 320, any one or more of the processes included in method 300 may be repeated in order to satisfy additional microparticle delivery requests. In other words, any one or more of the processes included in method 300 may be repeated for subsequently received microparticle delivery request.

Again, the operations and sub-operations of method 300 are able to evaluate microparticle delivery requests, generate (e.g., design and construct) a 4D object configured to satisfy the request efficiently, and improve performance of the 4D object over time based on use. Method 300 is thereby able to process microparticles and deliver them to intended target locations despite spatial limitations being involved. Implementations herein achieve this significant increase in the applicability of microparticles as a result of developing (e.g., designing and constructing) 4D objects that are configured to transport microparticles to a target location. The process of developing the 4D objects involves using trained machine learning models to evaluate characterizing details of a microparticle delivery request received, and determine a 4D object configured to deliver the microparticles to a target location most efficiently.

As noted above, 4D objects may be able to generate motion without relying on any machinery. Rather, 4D objects herein are able to transport microparticles as a result of implementing smart materials in different configurations that allow for the 4D objects to move in the presence of one or more influencing factors. Characteristics of the 4D objects can also be adjusted based on the target location for the microparticles and/or any details along the way. This allows approaches herein to monitor motion of the 4D objects while in use, and dynamically redirect the objects towards their respective targets in real-time. As a result, implementations herein are able to create a 4D object that is configured to efficiently deliver the microparticles to a target location, as well as monitor and refine performance of the 4D object. This allows for performance to be improved even further over time as the machine learning models become further trained.

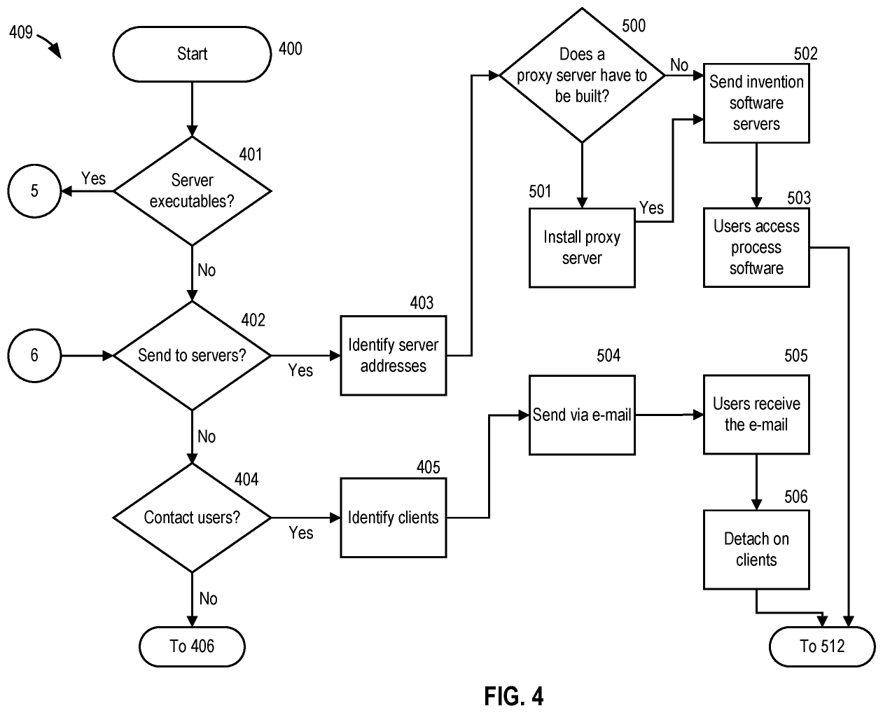

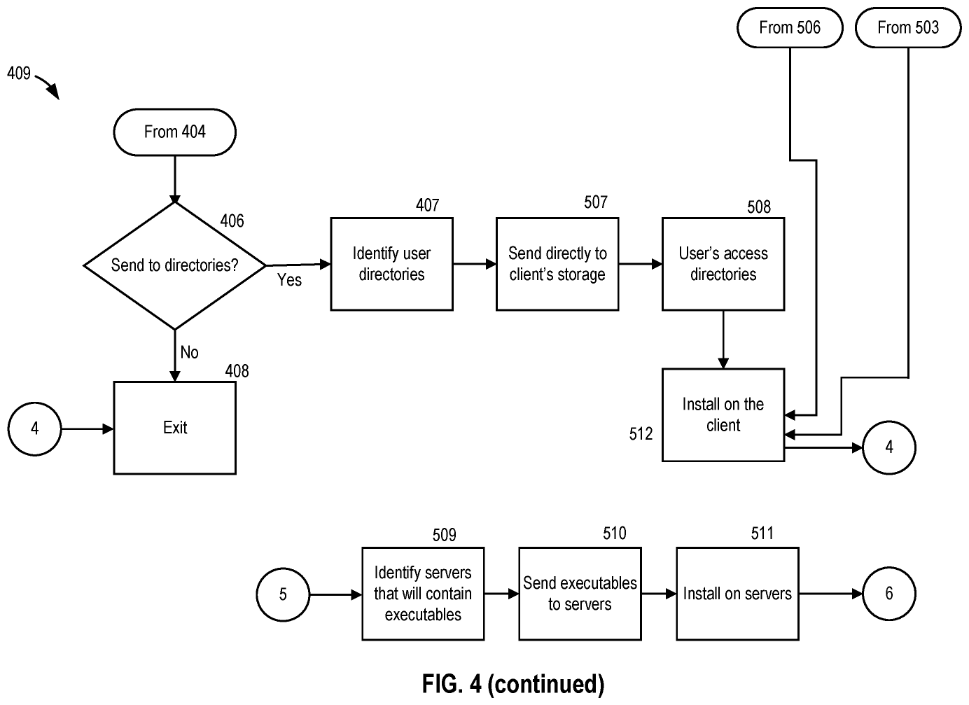

Now referring to FIG. 4, a flowchart of a method 409 is shown according to one approach. The method 409 may be performed in accordance with the present disclosure in any of the environments depicted in FIGS. 1-3B, among others, in various approaches. Of course, more or fewer operations than those specifically described in FIG. 4 may be included in method 409, as would be understood by one of skill in the art upon reading the present descriptions.

Each of the steps of the method 409 may be performed by any suitable component of the operating environment. For example, in various approaches, the method 409 may be partially or entirely performed by a processing circuit, e.g., such as an IaC access manager, or some other device having one or more processors therein. The processor, e.g., processing circuit(s), chip(s), and/or module(s) implemented in hardware and/or software, and preferably having at least one hardware component, may be utilized in any device to perform one or more steps of the method 409. Illustrative processors include, but are not limited to, a central processing unit (CPU), an application specific integrated circuit (ASIC), a field programmable gate array (FPGA), etc., combinations thereof, or any other suitable computing device known in the art.

While it is understood that the process software associated with evaluating microparticle delivery requests, generating (e.g., designing and constructing) a 4D object configured to satisfy the request efficiently, and improving performance of the 4D object over time based on use, may be deployed by manually loading it directly in the client, server, and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

With continued reference to method 409, step 400 begins the deployment of the process software. An initial step is to determine if there are any programs that will reside on a server or servers when the process software is executed (401). If this is the case, then the servers that will contain the executables are identified (509). The process software for the server or servers is transferred directly to the servers' storage via FTP or some other protocol or by copying though the use of a shared file system (510). The process software is then installed on the servers (511).

Next, a determination is made on whether the process software is to be deployed by having users access the process software on a server or servers (402). If the users are to access the process software on servers, then the server addresses that will store the process software are identified (403).

A determination is made if a proxy server is to be built (500) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (501). The process software is sent to the (one or more) servers either via a protocol such as FTP, or it is copied directly from the source files to the server files via file sharing (502). Another approach involves sending a transaction to the (one or more) servers that contained the process software, and have the server process the transaction and then receive and copy the process software to the server's file system. Once the process software is stored at the servers, the users via their client computers then access the process software on the servers and copy to their client computers file systems (503). Another approach is to have the servers automatically copy the process software to each client and then run the installation program for the process software at each client computer. The user executes the program that installs the process software on his client computer (512) and then exits the process (408).

In step 404 a determination is made whether the process software is to be deployed by sending the process software to users via e-mail. The set of users where the process software will be deployed are identified together with the addresses of the user client computers (405). The process software is sent via e-mail (504) to each of the users' client computers. The users then receive the e-mail (505) and then detach the process software from the e-mail to a directory on their client computers (506). The user executes the program that installs the process software on his client computer (512) and then exits the process (408).

Lastly, a determination is made on whether the process software will be sent directly to user directories on their client computers (406). If so, the user directories are identified (407). The process software is transferred directly to the user's client computer directory (507). This can be done in several ways such as, but not limited to, sharing the file system directories and then copying from the sender's file system to the recipient user's file system or, alternatively, using a transfer protocol such as File Transfer Protocol (FTP). The users access the directories on their client file systems in preparation for installing the process software (508). The user executes the program that installs the process software on his client computer (512) and then exits the process (408).

It will be further appreciated that approaches of the present disclosure may be provided in the form of a service deployed on behalf of a customer to offer service on demand.

The descriptions of the various approaches of the present disclosure have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A computer-implemented method, comprising:
sending one or more instructions to apply an initial influencing factor to smart materials of a 4-dimensional (4D) object, wherein the 4D object is configured to deliver one or more microparticles from a start location to a target location along a delivery path in response to the initial influencing factor being applied to the smart materials;
sending one or more instructions to monitor movement of the 4D object along the delivery path in response to applying the initial influencing factor to the smart materials; and
in response to determining the 4D object has deviated from the delivery path, sending one or more instructions to use one or more machine learning models to dynamically weight the initial influencing factor applied to the smart materials.

2. The computer-implemented method of claim 1, wherein sending one or more instructions to use the one or more machine learning models to dynamically weight the initial influencing factor, includes:
determining an amount of force generated by the 4D object in response to the initial influencing factor being applied to the smart materials;
comparing the amount of force generated by the 4D object, to the movement of the 4D object along the delivery path in response to applying the initial influencing factor to the smart materials; and
generating a weight value configured to adjust movement of the 4D object back along the delivery path in response to applying the weight value to the initial influencing factor.

3. The computer-implemented method of claim 1, wherein the 4D object includes the smart materials and static materials, wherein the smart materials are configured to physically deform in response to the initial influencing factor being applied thereto.

4. The computer-implemented method of claim 3, wherein the smart materials are configured to generate a force capable of physically moving the 4D object, as a result of being physically deformed.

5. The computer-implemented method of claim 3, wherein the one or more machine learning models are trained using a repository of characteristic data corresponding to different influencing factors and how they impact the physical deformation of different smart materials.

6. The computer-implemented method of claim 5, wherein the repository includes characteristic data corresponding to different ambient environments and how they impact the physical deformation of the respective smart materials in the repository.

7. The computer-implemented method of claim 1, wherein the influencing factor is selected from the group consisting of: light, heat, magnetic fields, sound, and electricity.

8. The computer-implemented method of claim 1, further comprising:
in response to determining that the 4D object has not deviated from the delivery path, sending one or more instructions to maintain the initial influencing factor applied to the smart materials; and
in response to determining that the 4D object has reached the target location, sending one or more instructions to remove the initial influencing factor from being applied to the smart materials.

9. A computer program product, comprising a computer readable storage medium having program instructions embodied therewith, the program instructions readable by a processor, executable by the processor, or readable and executable by the processor, to cause the processor to:
send one or more instructions to apply an initial influencing factor to smart materials of a 4-dimensional (4D) object, wherein the 4D object is configured to deliver one or more microparticles from a start location to a target location along a delivery path in response to the initial influencing factor being applied to the smart materials;
send one or more instructions to monitor movement of the 4D object along the delivery path in response to applying the initial influencing factor to the smart materials; and
in response to determining the 4D object has deviated from the delivery path, send one or more instructions to use one or more machine learning models to dynamically weight the initial influencing factor applied to the smart materials.

10. The computer program product of claim 9, wherein sending one or more instructions to use the one or more machine learning models to dynamically weight the initial influencing factor, includes:
determining an amount of force generated by the 4D object in response to the initial influencing factor being applied to the smart materials;
comparing the amount of force generated by the 4D object, to the movement of the 4D object along the delivery path in response to applying the initial influencing factor to the smart materials; and
generating a weight value configured to adjust movement of the 4D object back along the delivery path in response to applying the weight value to the initial influencing factor.

11. The computer program product of claim 9, wherein the 4D object includes the smart materials and static materials, wherein the smart materials are configured to physically deform in response to the initial influencing factor being applied thereto.

12. The computer program product of claim 11, wherein the smart materials are configured to generate a force capable of physically moving the 4D object, as a result of being physically deformed.

13. The computer program product of claim 11, wherein the one or more machine learning models are trained using a repository of characteristic data corresponding to different influencing factors and how they impact the physical deformation of different smart materials.

14. The computer program product of claim 13, wherein the repository includes characteristic data corresponding to different ambient environments and how they impact the physical deformation of the respective smart materials in the repository.

15. The computer program product of claim 9, wherein the influencing factor is selected from the group consisting of: light, heat, magnetic fields, sound, and electricity.

16. The computer program product of claim 9, wherein the program instructions are readable and/or executable by the processor to cause the processor to:
in response to determining that the 4D object has not deviated from the delivery path, send one or more instructions to maintain the initial influencing factor applied to the smart materials; and
in response to determining that the 4D object has reached the target location, send one or more instructions to remove the initial influencing factor from being applied to the smart materials.

17. A system, comprising:
a processor; and
logic integrated with the processor, executable by the processor, or integrated with and executable by the processor, the logic being configured to:
send one or more instructions to apply an initial influencing factor to smart materials of a 4-dimensional (4D) object, wherein the 4D object is configured to deliver one or more microparticles from a start location to a target location along a delivery path in response to the initial influencing factor being applied to the smart materials;
send one or more instructions to monitor movement of the 4D object along the delivery path in response to applying the initial influencing factor to the smart materials; and
in response to determining the 4D object has deviated from the delivery path, send one or more instructions to use one or more machine learning models to dynamically weight the initial influencing factor applied to the smart materials.

18. The system of claim 17, wherein sending one or more instructions to use the one or more machine learning models to dynamically weight the initial influencing factor, includes:
determining an amount of force generated by the 4D object in response to the initial influencing factor being applied to the smart materials;
comparing the amount of force generated by the 4D object, to the movement of the 4D object along the delivery path in response to applying the initial influencing factor to the smart materials; and
generating a weight value configured to adjust movement of the 4D object back along the delivery path in response to applying the weight value to the initial influencing factor.

19. The system of claim 17, wherein the 4D object includes the smart materials and static materials, wherein the smart materials are configured to physically deform in response to the initial influencing factor being applied thereto.

20. The system of claim 17, wherein the logic is configured to:
in response to determining that the 4D object has not deviated from the delivery path, send one or more instructions to maintain the initial influencing factor applied to the smart materials; and
in response to determining that the 4D object has reached the target location, send one or more instructions to remove the initial influencing factor from being applied to the smart materials.
